(19) United States
(12) Patent Application Publication
(10) Pub. No.: US 2011/0140294 A1
(43) Pub. Date: Jun. 16, 2011

(54) Sulphur Granulation Apparatus and Process

(76) Inventors: Brian Pyke, Langdon (CA); Robert Best, Calgary (CA); Nicholas Rasberry, Calgary (CA)

(21) Appl. No.: 13/001,443

(22) PCT Filed: Jun. 27, 2008
(86) PCT No.: PCT/CA2008/001207

§ 371 Date: Feb. 28, 2011

(51) Int. Cl. B29B 9/00; B29B 9/08

(52) U.S. Cl. 264/6; 425/8

(57) ABSTRACT

A portable apparatus for producing sulphur granules includes a granulator with a rotatable drum having distinct zones for seed generation and product growth. The seed generation zone has an intense water spray pattern for each sulphur spray nozzle with intersecting water sprays to solidify molten sulphur and create seeds. The growth zone has a moderate, non-intersecting water spray pattern to allow sulphur nozzles to coat and grow a curtain of seeds into granules. The granulator's exhaust air is filtered either by a heated cyclone separator to recapture residual sulphur particles and moisture before venting, and/or by a granular air filter which uses the produced granules to filter the granulator's exhaust air. A two piece collar enhances maintenance of the granulator's drive system.

### FIELD OF THE INVENTION

The present invention relates to an apparatus and process for the granulation of liquified substances, and in particular to forming generally spherical sulphur granules from molten sulphur.

### BACKGROUND OF THE INVENTION

Sulphur is a by-product of sour petroleum production, usually oil and natural gas. Previously, extracted sulphur was typically dried and solidified (i.e. “frozen”) into large blocks for on-site storage, and then broken down for transportation elsewhere. Such blocks were inconvenient to handle, created much unwanted dust and did not compact efficiently for transport, as too many voids resulted. Hence, processes were developed as early as the 1970s to create spherical granules of sulphur, as such granules resulted in easier handling, including less dust during handling, and better storage and more efficient transportation due to improved bulk density when both poured and packed (i.e. fewer unnecessary voids).

However, these earlier granulation processes, and the apparatuses for carrying out these process, suffered from many disadvantages. Some required several passes through a device to form the product, or the drums needed to be seeded from other sources, while others could not adequately control the quality of produced product as seed or granule formation was not adequately controlled. Granule production plants were also constructed to produce very large volumes (e.g. 55-60 tonnes/hr), had relatively large footprints and were rather expensive to manufacture and operate. This either limits or eliminates their desirability in smaller production and refinery facilities. The reality in today's market is that there are greater numbers of smaller-scale sulphur production operations, and that sulphur producers require granulation equipment that is smaller in scale and more portable.

What is therefore desired is a novel sulphur granulation apparatus of more compact and cost effective design that overcomes the above disadvantages and provides a more efficient process to achieve granules of desired quality. It should be a completely self-contained granulation process where in essence the only emission is scrubbed process air. It should preferably be transportable.

### SUMMARY OF THE PRESENT INVENTION

According to the present invention, there is provided in one aspect an apparatus for producing granular particles comprising:

a support frame;

an elongate hollow drum rotatably mounted on the support frame having a first end and an opposed second end lying along a longitudinal axis of rotation;

means on the support frame for rotating the drum about the axis;

a plurality of flights circumferentially spaced inside the drum for creating a curtain of falling particles during rotation;

a processing fluid conduit extending in the drum and having a plurality of processing fluid nozzles spaced therealong for spraying the processing fluid in a predetermined spray pattern;

a cooling fluid conduit extending in the drum providing a plurality of cooling fluid nozzles for spraying cooling fluid, a first segment of the cooling fluid nozzles defining a seed generation zone by providing an intense cooling fluid spray pattern for a first portion of the processing fluid nozzles to create solid seed particles, and a second segment of the cooling fluid nozzles defining a product growth zone by providing a moderate cooling fluid spray pattern for a second portion of the processing fluid nozzles to grow the seed particles to granular particles;

a drying means for introducing a drying gas into the drum along the axis to flush unwanted moisture and dust in an exhaust air stream; and,

an outlet at the second end for the exhaust air stream and for removing the granular particles from the drum.

In another aspect the invention provides a cyclone separator for filtering the exhaust air stream.

In yet another aspect the invention provides a granular air filter for filtering the exhaust air stream, whether in place of or in conjunction with the cyclone separator.

In yet another aspect a split ring collar is provided for drum maintenance and operation.

In another aspect the invention provides a granulation process for producing granular particles comprising:

a) rotating an elongate hollow drum having a first end and an opposed second end lying along a longitudinal axis of rotation;

b) spraying a processing fluid in a processing fluid spray pattern having first and second portions inside the drum;

c) spraying a cooling fluid inside the drum in a first segment defining a seed generation zone by providing an intense cooling fluid spray pattern for the first portion of the processing fluid spray to create solid seed particles, and in a second segment defining a product growth zone by providing a moderate cooling fluid spray pattern for the second portion of the processing fluid spray to grow the seed particles to granular particles;

d) creating a curtain of falling particles inside the drum during rotation;

e) introducing a drying gas into the drum along the axis to flush unwanted moisture and dust in an exhaust air stream; and,

f) removing the granular particles and exhaust air stream through an outlet at the second end of the drum.

### BRIEF DESCRIPTION OF THE DRAWING FIGURES

Embodiments of the invention will now be described, by way of example only, with reference to the accompanying drawings, wherein:

FIG. 1 is a schematic of the granulation process and shows certain components of the apparatus according to a preferred embodiment of the present invention;

FIG. 2a is an isometric view of the granulation apparatus according to a preferred embodiment of the present invention;

FIG. 2b is a front elevation view of the apparatus of FIG. 2a;

FIG. 2c is a plan view of the apparatus of FIG. 2a;

FIG. 2d is an end elevation view of the apparatus viewed from the right of FIG. 2b;

FIG. 3a is an isometric view of a top portion of the apparatus of FIG. 2a, namely the drum and cyclone separator portions of the apparatus;

FIG. 3b is a front elevation view of FIG. 3a;

FIG. 3c is a plan view of FIG. 3b;

FIG. 3d is a sectional view along line 3d-3d in FIG. 3c;

FIG. 3e is a cross-sectional view along line 3e-3e in FIG. 3b;

FIG. 3f is a cross-sectional view along line 3f-3f in FIG. 3b;

FIG. 3g is a cross-sectional view along line 3g-3g in FIG. 3g;

FIG. 3h is a detailed view of the circled area in FIG. 3d identified by reference numeral 3h showing a drum seal arrangement;

FIG. 4a is a more detailed elevational view of the spray bar arrangement seen in FIG. 3d;

FIG. 4b is a cross-sectional view along line 4b-4b in FIG. 4a;

FIG. 4c is a cross-sectional view along line 4c-4c in FIG. 4a;

FIG. 5a is an isometric view of the drum shown in FIG. 3a;

FIG. 5b is an isolated isometric view of a circumferential collar from the drum of FIG. 5a;

FIG. 5c is a more detailed plan view of the circled portion in FIG. 5b identified by reference numeral 5c;

FIG. 6a is an isometric view of a cyclone separator of FIG. 3a shown in isolation;

FIG. 6b is an isometric view of the cyclone separator of FIG. 6a shown from the opposite side;

FIG. 6c is an elevational view from the left side of FIG. 6a;

FIG. 6d is a cross-sectional view along line 6d-6d of FIG. 6c;

FIGS. 6e to 6g are views of FIG. 6c from the top, bottom and left sides, respectively; and,

FIG. 7 is a cross-sectional view of a preferred granular air filter for use with the present apparatus.

### DESCRIPTION OF PREFERRED EMBODIMENTS

The present invention is an apparatus (generally indicated in the figures by reference numeral 10) and process for producing granular particles from processing fluids in a single pass through the apparatus. The particles may also be referred to herein as granular solids, granules or “product”, and the processing fluids may encompass a known range of suitable liquified substances, such as urea and bentonite fertilizers. For illustrative purposes, the preferred processing fluid is a molten sulphur for forming sulphur granules. It is also noted that terms such as “front”, “rear”, “upper”, “lower” and the like may also be used for identifying certain features of the apparatus. The use of these terms is not necessarily intended to limit its use or orientation. Further, when describing the invention, all terms not defined herein have their common art-recognized meaning.

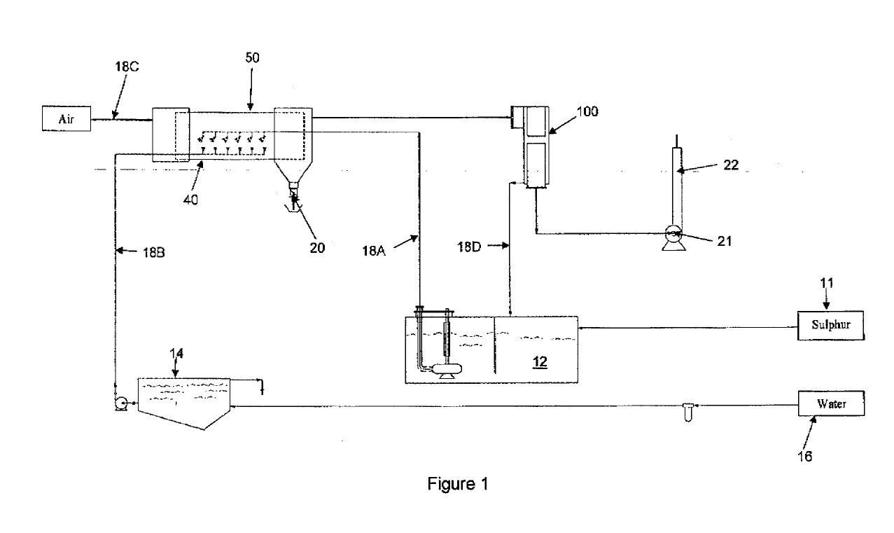

With reference first to FIG. 1, the present granulation process involves the introduction of sulphur from a sulphur source 11, such as a sour gas processing plant, to a heated reservoir 12 of molten sulphur. Likewise, a cooling fluid, usually water, is kept in another reservoir 14 and replenished as required from a water source, such as a well. The molten sulphur and water are each piped via dedicated lines 18a, 18b, respectively, into a granulator 40 where they are individually dispersed in predetermined spray patterns within a rotating drum 50 to form sulphur seeds which are grown into sulphur granules within a desired size range and then exit the drum at 20 into a suitable container (not shown) for on-site storage or transport elsewhere. A drying medium, which in this case is a drying gas such as ambient air, is drawn via a line 18c into the drum's inlet end as “clean air” to flush unwanted moisture and residual sulphur particles, namely “dust” or “fines”, which exit as “dirty air” in an exhaust air stream through the drum's opposed outlet end and proceeds into a cyclone separator 100 where the residual particles are substantially separated from the air. The cleaned air is vented back to the ambient at 22, whereas the residual particles are melted within the heated separator and are returned via line 18d to the sulphur reservoir for re-use by the present process.

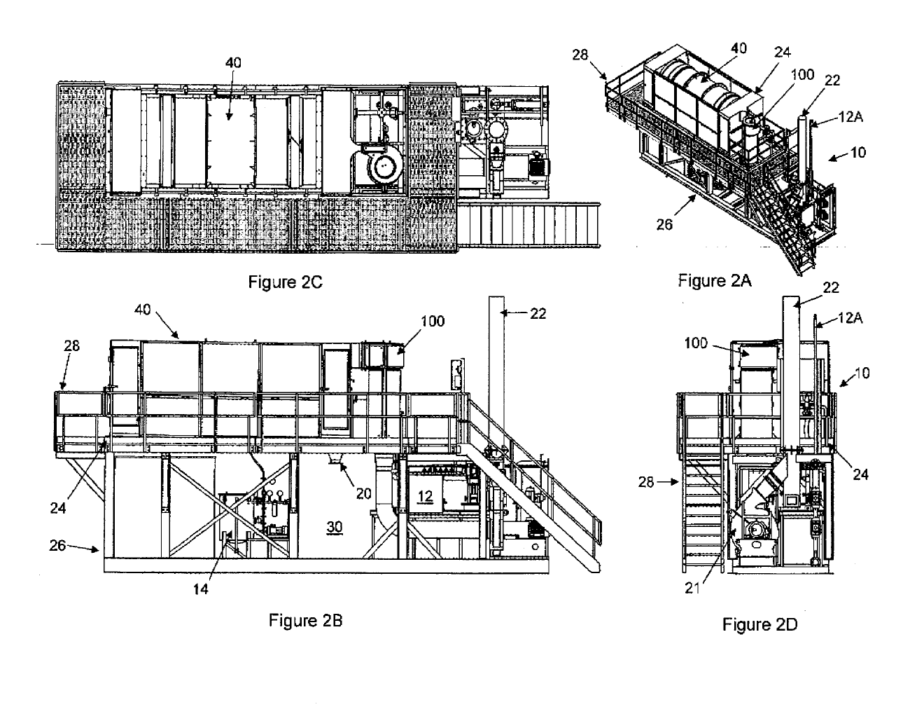

The various components of this process will now be described in more detail. Reference is now made to FIGS. 2a to 2d which provide an overview of the apparatus 10 of this invention. An attractive practical feature of the apparatus is its portability. The apparatus in essence rests on two transportable skids, namely an upper drum skid 24 supporting the granulator 40 and cyclone separator 100, and a lower steel-framed base skid 26 for supporting the remaining features such as the water reservoir 14 and sulphur reservoir 12. Generally speaking, assembly of the apparatus at a desired location requires mounting of the drum skid onto the base skid, adding the access platform and stairs 28, raising the sulphur reservoir stack 12a, adding the clean air vent stack 22 atop the exhaust fan 21, and connecting other peripherals. The assembled base provides a port area 30 with easy access for containers to receive the produced sulphur granules from the granule exit point 20.

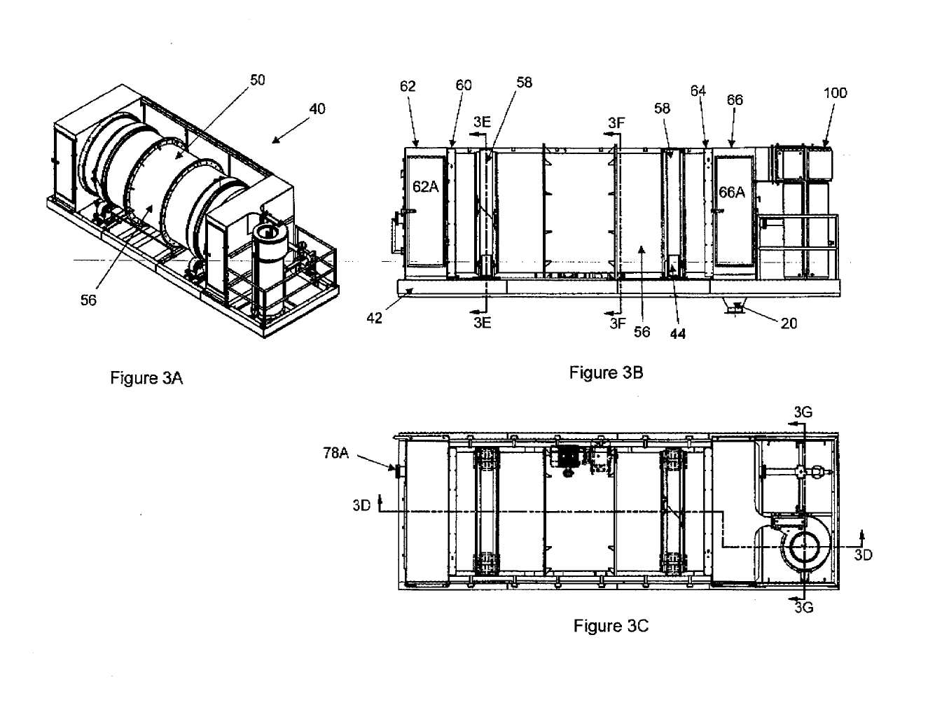

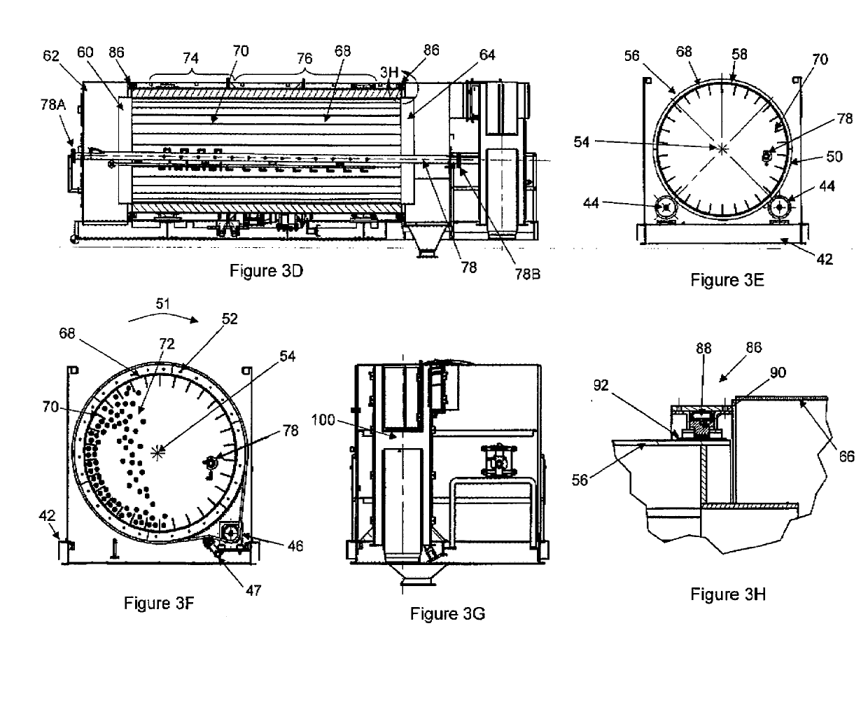

One of the key components of the apparatus is the granulator 40 shown in isolation and greater detail in FIGS. 3a to 3h. A support frame 42 holds an elongate hollow drum 50 of circular cross-section having a longitudinal axis 54 that is oriented generally horizontally during operation, namely the drum should have a slight downslope (up to about 2 degrees) to encourage flow of product toward the discharge end of the drum. The drum's circular outer surface 56 is fitted with at least two longitudinally spaced collars 58 extending circumferentially thereabout to form fortified smooth tracks for engaging a drum trunion assembly whose rollers 44 rotatably support the drum on the support frame 42. A belt or chain drive assembly 46 rotates the drum on the rollers 44 about the axis 54 at desired speeds. A chain tensioner 47 urges proper contact with the drum during operation. The drum has a first open inlet end 60 which is rotatably sealed to an inlet plenum 62, and an opposed second open discharge end 64 rotatably sealed to a discharge plenum 66, both employing an improved seal assembly 86 shown in FIG. 3h and discussed in greater detail later. Both plenum areas 62,66 have air tight user access doors 62a, 66a for accessing the granulator's interior components.

The drum's interior is defined by a substantially smooth, non-perforated, cylindrical inner wall 68 having a plurality of particle lifting flights 70 pointing radially inwardly which are uniformly and circumferentially spaced and substantially extend the length of the drum 50. It will be appreciated that rotation of the drum in a clockwise direction, as viewed in FIG. 3f and indicated by arrow 51, allows the flights to lift granules (at their various stages of formation) from the bottom of the drum and then drop the granules to create a generally uniform curtain of granules 72 spaced from the sides of the drum and extending longitudinally along the drum. It will be appreciated that the drum's direction of rotation moves the bed of granules in a direction away from the sulphur and water spray nozzles (as will be described below) and forms the granule curtain 72 on the opposite side of the axis of rotation 54 to avoid unnecessary impact with the nozzles.

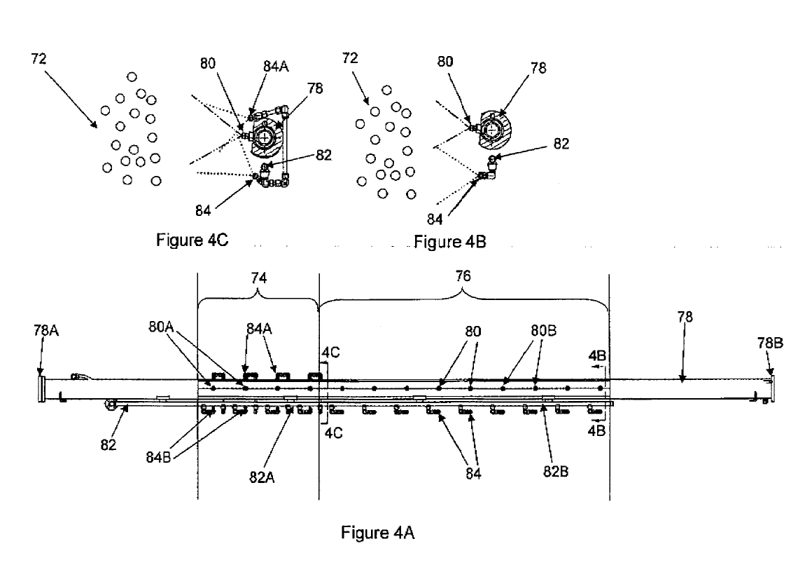

Referring now as well to FIGS. 4a to 4c, an important aspect of the granulator is the design of the fluid conduits passing into the drum defining a seed generation zone 74 proximate the drum's inlet end 60 for creating sulphur seed particles, and a product growth zone 76 downstream of the seed generation zone and proximate the drum's discharge end 64 for further growing the seed particles in a “size enlargement process” into the desired size of sulphur granules. A processing fluid conduit 78 for delivery of pressurized molten sulphur into the granulator extends through the drum 50 parallel to and off-set from the drum's longitudinal axis 54 and is fixed outside the drum to the support frame 42 to remain stationary during operation. One end 78a of the conduit is capped, and the opposed end 78b communicates with the sulphur reservoir 12 via the sulphur delivery line 18a. A plurality of sulphur nozzles 80 extend along the conduit and are longitudinally spaced within the drum for spraying the molten sulphur in a predetermined spray pattern generally toward the drum centre 54. In the preferred embodiment, a total of thirteen sulphur nozzles 80 are provided with a first portion 80a of these nozzles (namely four) being in the seed generation zone 74 and the second portion 80b (namely the remaining nine sulphur nozzles) being in the product growth zone 76. It will be appreciated that the exact number of nozzles can vary to suit specific design and production needs.

A means for contacting the hot sulphur spray with a cooling fluid, preferably water, is likewise provided in the form of a water conduit 82 located longitudinally in the drum and closely spaced to the sulphur conduit 78, and has a plurality of longitudinally spaced water nozzles 84 therealong for spraying water. A first segment 82a of these water nozzles is located in the seed generation zone 74 for wetting and rapidly cooling the sprayed sulphur to a temperature range below sulphur's melting point to solidify the sprayed sulphur into the desired seed particles. A second segment 82b of the water nozzles is located in the product growth zone 76 to promote growth of the sulphur granules by keeping the granules cool (i.e. below the melting point of sulphur) to ensure solidification as they are coated with additional layers of sprayed sulphur thereon.

In the preferred embodiment the seed generation zone is defined by certain features of the water spray system which provide an intense water spray pattern. Firstly, the first segment 82a of water nozzles in the seed generation zone has a first portion of water nozzles, identified by 84a, that are located opposite a second portion of the water nozzles, identified by 84b, so that the sulphur nozzles 80 are framed intermediate these water nozzles 84a and 84b. Specifically, the upper and lower water nozzles 84a, 84b are located above and below, respectively, of respective sulphur nozzles 80, and are vertically aligned with these sulphur nozzles (i.e. all are in the same vertical plane). Secondly, each of the upper water nozzles 84a are directed downwardly toward the sprayed sulphur exiting a respective sulphur nozzle 80, and likewise each of the lower nozzles 80b are directed upwardly toward a respective sulphur nozzle, as best seen in FIGS. 4a & 4c. In other words, each water nozzle 84a, 84b is directed or aimed at a sulphur nozzle 80 to provide an “intersecting” spray. Such spray pattern from two sides helps generate the desired solid sulphur seeds.

The water spray pattern in the downstream product growth zone 76 is substantially different and more moderate since the goal is to merely provide enough water to continue to keep the granules cool in the falling sulphur curtain as the cascading granules are coated with more layers of molten sulphur from the sulphur nozzles 80 in that zone. Although the water nozzles 84 are vertically aligned with the sulphur nozzles as in the seed generation zone, they are aimed away from the sulphur nozzles 80 and toward the granule curtain 72, as best seen in FIG. 4b, to provide a “non-intersecting” spray pattern. Further, a water nozzle to sulphur nozzle ratio of about 1:1 is adequate in the product growth zone. In contrast, the seed generation zone uses higher ratios, namely 2:1. Although the water nozzles 84 in the second segment of the conduit 82b shown in FIG. 4a are located below the sulphur nozzles 80, similar results should be achieved if the same water nozzle arrangement were instead placed above the sulphur nozzles in the product growth zone.

As water is introduced into the drum to cool the sprayed molted sulphur, steam or moisture is generated which must be removed. A drying means in the form of the exhaust fan 21 draws drying gas, preferably ambient air, from the drum's inlet to discharge ends 60, 64 and creates a negative pressure inside relative to the ambient. Openings 18c in the inlet plenum 62 allow atmospheric air to be drawn into the granulation process. As the air passes lengthwise through the drum it also picks up residual sulphur dust. The resulting “dirty air” forms an exhaust air stream that passes through the drum's discharge end and the discharge plenum 66, into the cyclone separator 100 and then out the vent 22.

The negative air pressure is maintained in the drum and adjacent portions of the granulator to avoid unwanted egress of sulphur particles or other deleterious matter to the ambient during operation. As such, an effective seal 86 is also provided between the outer edge of the rotating drum and the stationary inlet and outlet plenums 62, 66 at each end of the drum to prevent air flow, either into or out of the drum. Shown in greater detail in FIG. 3h, the seal in essence utilizes an inflatable air bladder 88 (whose inflation level can be maintained through a valve, not shown) to urge a removable and replaceable wear block into a sliding sealing engagement against a Teflon™, or equivalent, pad 92 extending circumferentially about the drum's outer surface. This arrangement allows the sealing effect to be maintained during drum rotation regardless of most expected deviations in the drum's surface, deflections, vibrations and the like.

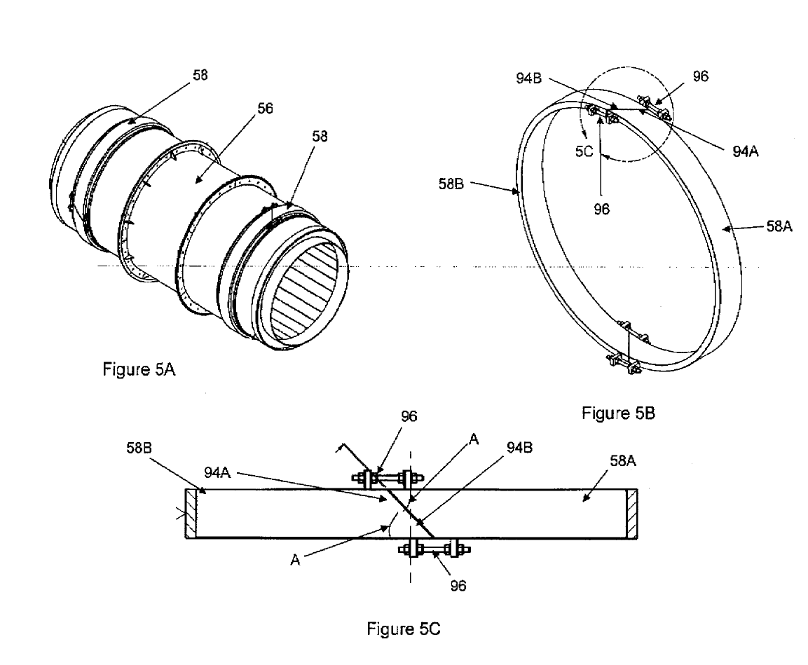

Such deviations in the drum's rotation are reduced by proper maintenance of the earlier-noted collars 58 on the drum's outer surface. With reference to FIGS. 5a to 5c, the illustrated improved collar 58, also termed a “tire”, advantageously provides for more convenient replacement of worn or damaged collars by avoiding the inherent and known drawbacks of removing and inserting one piece collars from such large circular shells. Rather, the current collar provides a split ring arrangement having first and second circumferential portions 58a, 58b to allow for radial rather than longitudinal removal/insertion from/to the drum. The wedge-shaped ends 94a, 94b of the collar portions are cut at complimentary 45 degree splits (i.e. angle A is about 45 degrees) so when brought together in a facing but slightly spaced relationship, the frame support rollers 44 may pass over any resulting gap in the joint with much less disturbance than if the joint were a 90 degree transverse cut. The means for fixing the collar portions must not interfere with the rolling action of the drum on the rollers, and so the illustrated nut and bolt arrangement 96 is provided on each side of the collar portions, and spans the split so that twisting of the nuts will allow the bolt to either draw or separate the split joint as required. The collar should be dimensioned so that an initial friction fit on the drum leaves a small gap in the split for future tightening should the collar expand with use.

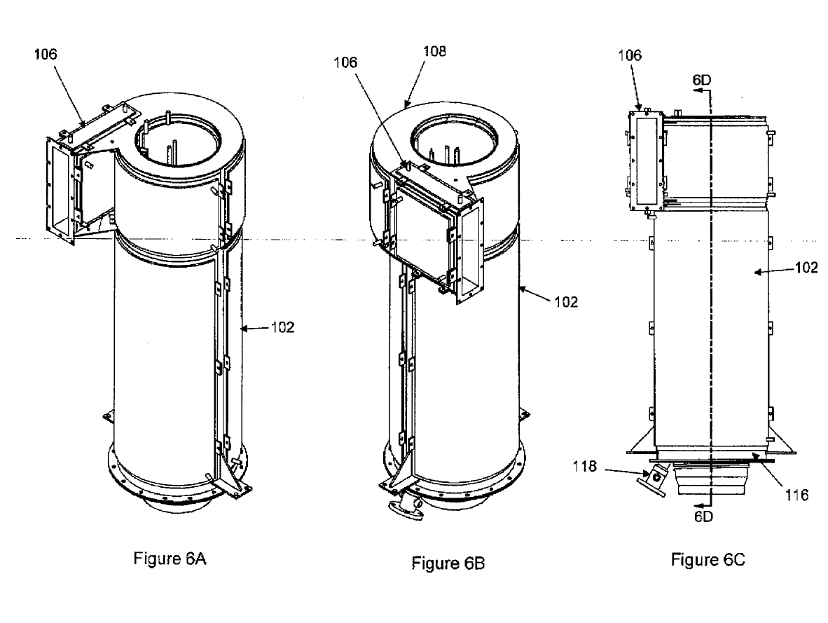

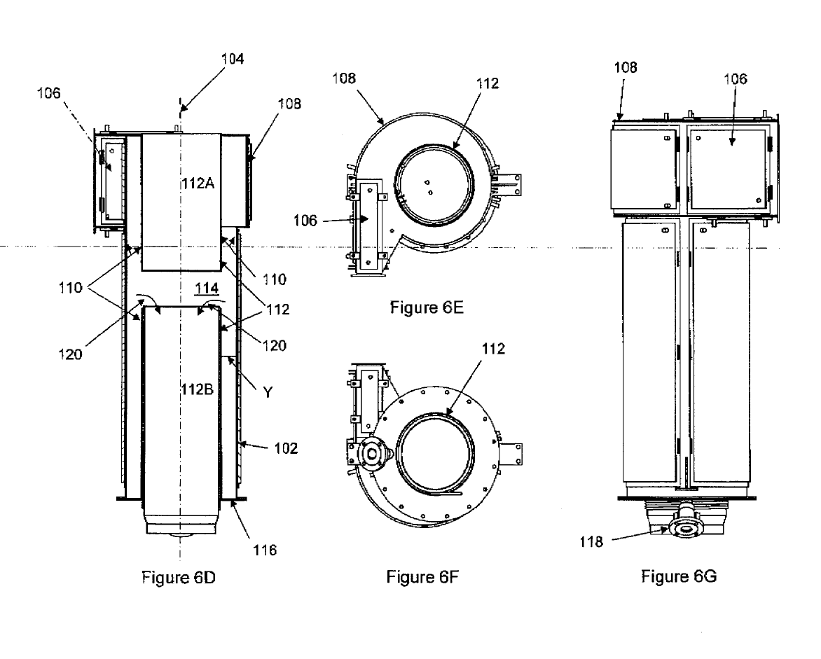

Another key component and important aspect of the apparatus is the filtering system for the granulator's exhaust air stream, namely the cyclone separator 100 for removing residual sulphur particles and moisture trapped in the exhaust air stream. Referring in greater detail to FIGS. 6a to 6g, in addition to the earlier FIGS. 2a to 3g, the cyclone separator 100 has a generally cylindrical hollow body 102 with a longitudinal axis 104. An inlet 106 for the granulator's exhaust air stream is oriented tangentially to the axis 104, and an arcuate smoothing plate 108 downstream of the inlet both promote a generally laminar flow of the incoming exhaust air with reduced turbulence inside the separator, which should enhance the amount of particulates contacting the separator's heated inside surfaces 110. All internal surfaces are heated by plate coils placed on the external walls. A co-axially disposed cylindrical inner tube 112 is closely spaced (indicated by “Y”) to the body 102 and has an air gap 114 along its length, effectively creating upper and lower inner tube portions 112a, 112b which define opposed “vortex finders”. This gap 114 provides a desirable and greater than normal pressure drop within the separator which, when coupled with the close spacing Y, provides high velocities to the incoming air stream about the axis 104 to drive more particulates toward the separator's heated outer body. The heated portions of the separator are heated to a temperature above the sulphur's melting point so as to remelt the contacting particulates to a liquid state so that it may descend by gravity to the separator's floor and which then drains through the outlet 118 into the sulphur return line 18d and back into the sulphur reservoir 12 for re-use. The cleaned exhaust air travels through the open-topped lower tube 112b (as indicated by arrows 120) and is drawn by the fan 21 and expelled to the ambient through vent 22. The upper inner tube 112a is closed at its bottom and does not receive any of the cleaned air. It will be appreciated that the separator is mounted generally vertically on its longitudinal axis to maximize gravity's effect on the re-melted particulates, but that other orientations may work adequately as well.

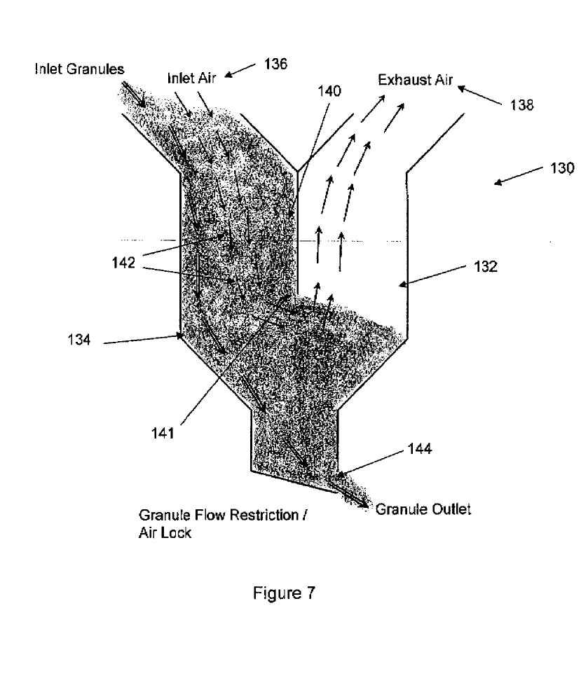

In another embodiment of the apparatus, the separator 100 is replaced by a granular air filter 130 shown in FIG. 7 for performing the same exhaust air cleaning function. The filter 130 uses the sulphur granules produced in the granulator to in essence filter the air that was used to create those granules. The filter is formed by a vessel 132 having a bed 134 of sulphur granules, an inlet 136 for the exhaust air stream from the granulator 40, an air outlet 138 and a partition wall 140 for directing the incoming air stream through the granule bed (as indicated by arrows 142) to urge removal of the entrained particulates and moisture into the bed before being directed to the air outlet 138. The top of the bed 134 must be at least at the tip 141 of the partition to avoid dirty exhaust air bypassing the bed enroute to the air outlet 138, and preferably the depth of the bed is well above the tip 141 (as illustrated) to urge the exhaust air through a good volume of particles to ensure a desired level of air scrubbing. A bottom portion of the vessel has a granule outlet 144 for draining the bed when enough particulates and moisture have accumulated therein.

Although such replenishment of granules may be performed periodically based on certain parameters, in the preferred embodiment the bed 134 is continuously replenished with new sulphur granules from the granulator by diverting or directing some or all of the produced granules from the granulator into the inlet 136 to establish a desired continuous stream of granules into the top of the bed. Concurrently, the granule outlet 142 operates as an air lock to block air escape therethrough and a flow restrictor to control the outflow of granules from the bottom of the bed. The outflow control maintains the continuously replenishing bed at a predetermined level for a desired air flow and scrubbing quality through the filter.

In another embodiment the granular air filter 130 is used in conjunction with the separator 100, such as being in series with the separator 100 upstream thereof to clean the drum's exhaust air prior to its entry into the separator's inlet 106.

A control system is provided to monitor and control all aspects of the process and apparatus operation. For instance, the system adjusts water flow to the nozzles to maintain granule temperatures within a desired range when leaving the drum.

The operation of the granulation apparatus and the resulting granulation process, and some of the many advantages of the present invention, should now be better understood. Molten sulphur is sprayed into the rotating drum 50 though a number of longitudinally spaced sulphur nozzles 80 into two distinct zones, namely the seed generation zone 74 to form sulphur seeds and the downstream product growth zone 76 to further coat and grow those seeds into desired sulphur granules. The seed generation zone is characterized by an intense water spray pattern for each sulphur nozzle in that the sulphur spray exiting a nozzle is immediately impacted by a direct, intersecting water spray from respective upper and lower water nozzles 84a, 84b to create the desired sulphur seeds. The flights 70 of the rotating drum then begin forming a particle curtain 72 to carry these seeds into the product growth zone 76 where the sulphur spray coats the curtain of falling sulphur particles to grow the forming granules to a desired size and quality, namely a generally spherical granule, entirely dry and free of voids. The product growth zone is further characterized by a much less intense water spray pattern than in the seed generation zone, namely there is only a 1:1 ratio of water to sulphur nozzles, and the water nozzles provide a non-intersecting type of spray pattern that largely impacts the granule curtain to merely keep it cool (i.e. below sulphur's melting point). Air is passed along the drum to carry any dust and moisture to the drum's discharge end 64. In the preferred embodiment the granules are formed in a single pass through the granulator and thus exit at the drum's discharge end and fall through granule exit 20 into an appropriate hopper or other conveyance. In contrast, the drum's discharged air is filtered through the cyclone separator 100 where residual sulphur particles are captured, re-melted by the cyclone's heated interior walls and returned to the sulphur reservoir, whereas the cleaned air is vented to the ambient. A tangential inlet 106 and an arcuate smoothing plate 108 promote a generally laminar flow with reduced turbulence to enhance particle contact with the separator's heated surfaces, and vortex finders 112a, 112b enhance the pressure drop in the separator which helps impart high velocities to the incoming discharge air to drive more particles toward the separator's heated body 102. In an alternate embodiment a granular air filter is employed either in conjunction with, or in place of, the cyclone separator to use the generated sulphur granules to filter the discharge air stream from the drum. The granules in the filter are preferably continuously replenished by fresh granules from the drum. Further, desired maintenance of the drum is facilitated by the improved collars 58 whose 45 degree cut ends and clamping arrangement 96 provide for more convenient replacement of worn collars.

The above description is intended in an illustrative rather than a restrictive sense, and variations to the specific configurations described may be apparent to skilled persons in adapting the present invention to other specific applications. Such variations are intended to form part of the present invention insofar as they are within the spirit and scope of the claims below.

We claim:

1. Apparatus for producing granular particles comprising:
a support frame;
an elongate hollow drum rotatably mounted on the support frame having a first end and an opposed second end lying along a longitudinal axis of rotation;
means on the support frame for rotating the drum about the axis;
a plurality of flights circumferentially spaced inside the drum for creating a curtain of falling particles during rotation;
a processing fluid conduit extending in the drum and having a plurality of processing fluid nozzles spaced therealong for spraying the processing fluid in a predetermined spray pattern;
a cooling fluid conduit extending in the drum providing a plurality of cooling fluid nozzles for spraying cooling fluid, a first segment of the cooling fluid nozzles defining a seed generation zone by providing an intense cooling fluid spray pattern for a first portion of the processing fluid nozzles to create solid seed particles, and a second segment of the cooling fluid nozzles defining a product growth zone by providing a moderate cooling fluid spray pattern for a second portion of the processing fluid nozzles to grow the seed particles to granular particles;
a drying means for introducing a drying gas into the drum along the axis to flush unwanted moisture and dust in an exhaust air stream; and,
an outlet at the second end for the exhaust air stream and for removing the granular particles from the drum.

2. The apparatus of claim 1 wherein a first portion of the first segment of cooling fluid nozzles are each directed toward the sprayed processing fluid exiting a respective processing fluid nozzle in the first portion of processing fluid nozzles.

3. The apparatus of claim 1 wherein the first segment of cooling fluid nozzles has first and second portions of cooling fluid nozzles, and the first portion of processing fluid nozzles is located intermediate the first and second portions of the cooling fluid nozzles.

4. The apparatus of claim 3 wherein the first portion of cooling fluid nozzles is located above the first portion of processing fluid nozzles, and the second portion of cooling fluid nozzles is located below the first portion of processing fluid nozzles.

5. The apparatus of claim 2 wherein the first portion of cooling fluid nozzles is located above the first portion of processing fluid nozzles, and a second portion of the first segment of cooling fluid spray nozzles is located below the processing fluid nozzles.

6. The apparatus of claim 1 wherein the direction of the cooling fluid nozzles in the second segment is non-intersecting with the second portion of processing fluid nozzles.

7. The apparatus of claim 6 wherein said non-intersection comprises aiming the cooling fluid nozzles and processing fluid spray nozzles generally parallel.

8. The apparatus of claim 6 wherein a greater number of cooling fluid nozzles than processing fluid nozzles are provided in the seed generation zone.

9. The apparatus of claim 1 wherein the cooling fluid nozzles in the first segment thereof are each directed toward a respective processing fluid nozzle in the first portion thereof to directly intersect the processing fluid spray exiting same.

10. The apparatus of claim 9 wherein two cooling fluid nozzles in the first segment thereof are provided for each processing fluid nozzle in the first portion thereof.

11. The apparatus of claim 1 further comprising a filtering system for the exhaust air stream, the system including a cyclone separator for removing residual particles of solidified processing fluid and moisture trapped in the exhaust air stream.

12. The apparatus of claim 11 wherein the cyclone separator comprises a generally cylindrical hollow body having an inlet for the exhaust air stream oriented trangentially to a longitudinal axis of the body, an arcuate smoothing plate located downstream of the inlet to provide generally laminar flow of the incoming air stream with reduced turbulence to enhance the amount of particles contacting inside portions of the body, the inside portions being heated to a temperature above the melting point of the particles to provide remelted liquid, and an outlet for draining the liquid for optional reuse.

13. The apparatus of claim 12 wherein a cylindrical inner tube is co-axially disposed within the hollow body and is closely spaced thereto to provide high velocities to the incoming air stream about the separator's longitudinal axis.

14. The apparatus of claim 13 wherein the cylindrical inner tube includes an air gap along its length to provide a desired high pressure drop within the separator.

15. The apparatus of claim 1 comprising a filtering system for the exhaust air stream, the system including a granular air filter for removing residual particles of solidified processing fluid and moisture trapped in the exhaust air stream.

16. The apparatus of claim 11 comprising a filtering system for the exhaust air stream, the system including a granular air filter located upstream of the cyclone separator for removing residual particles of solidified processing fluid and moisture trapped in the exhaust air stream.

17. The apparatus of claim 15 wherein the granular air filter comprises a vessel for holding a bed of granular particles having an inlet for the exhaust air stream, an air outlet, a partition intermediate the inlet and outlet for directing the air stream into the bed of granular particles to urge removal of residual particles and moisture from the air stream before being directed to the air outlet.

18. The apparatus of claim 17 further including means for continuously replenishing the bed of granular particles comprising a communication means for diverting at least a portion of the granular particles from the drum outlet to the air filter inlet, and a granule restrictor for controlling the outflow of granular particles from the bed to maintain the desired air flow through the granular air filter by maintaining the bed at a predetermined level.

19. The apparatus of claim 18 wherein the granule restrictor also forms an air lock to avoid air flow therethrough.

20. The apparatus of claim 1 wherein the drum includes an outer circumferential collar for engaging a drum driving system on the support frame, the collar comprising a split ring arrangement having first and second circumferential portions which have complimentary wedge-shaped ends.

21. The apparatus of claim 20 wherein the wedged shaped ends are formed at substantially a 45 degree split.

22. The apparatus of claim 21 wherein the fixing means for the first and second portions comprises a nut and bolt arrangement on each lateral side of the collar to avoid contact with the drum driving system, and located to span the split to draw the wedge shaped surfaces toward themselves and thereby provide a frictional fit of the collar on said drum.

23. Process for producing granular particles comprising:
a) rotating an elongate hollow drum having a first end and an opposed second end lying along a longitudinal axis of rotation;
b) spraying a processing fluid in a processing fluid spray pattern having first and second portions inside the drum;
c) spraying a cooling fluid inside the drum in a first segment defining a seed generation zone by providing an intense cooling fluid spray pattern for the first portion of the processing fluid spray to create solid seed particles, and in a second segment defining a product growth zone by providing a moderate cooling fluid spray pattern for the second portion of the processing fluid spray to grow the seed particles to granular particles;
d) creating a curtain of falling particles inside the drum during rotation;
e) introducing a drying gas into the drum along the axis to flush unwanted moisture and dust in an exhaust air stream; and,
f) removing the granular particles and exhaust air stream through an outlet at the second end of the drum.

24. The process of claim 23 wherein creating the curtain of falling particles comprises providing a plurality of flights circumferentially spaced inside the drum.

25. The process of claim 23 comprising directing the first segment of the cooling fluid spray toward the first portion of the processing fluid spray to intersect therewith.

26. The process of claim 23 comprising providing the first segment of the cooling fluid spray from two sides onto the first portion of the processing fluid spray.

27. The process of claim 23 wherein the second segment of the cooling fluid spray is non-intersecting with the second portion of the processing fluid spray.

28. The process of claim 27 wherein the non-intersection comprises aiming the cooling fluid and the processing fluid sprays generally parallel.

29. The process of claim 23 further comprising filtering the exhaust air stream through a cyclone separator for removing any residual particles of solidified processing fluid and moisture trapped in the exhaust air stream.

30. The process of claim 23 further comprising filtering the exhaust air stream through a granular air filter for removing residual particles of solidified processing fluid and moisture trapped in the exhaust air stream.

31. The process of claim 29 further comprising adding a granular air filter upstream of the cyclone separator.

32. The process of claim 30 comprising diverting at least a portion of the granular particles from the drum outlet to the granular air filter.

33. The process of claim 23 including engaging the drum with an outer circumferential collar comprising a split ring arrangement.
